(19) United States
(12) Patent Application Publication
(10) Pub. No.: US 2025/0013816 A1
(43) Pub. Date: Jan. 9, 2025

(54) Systems and Methods for Visualization for Editing Hierarchical Markup Documents

(71) Applicant: Hexagon Technology Center GmbH, Heerbrugg (CH)

(72) Inventor: Keith D. Harvey, Huntsville, AL (US)

(21) Appl. No.: 18/214,322

(22) Filed: Jun. 26, 2023

(51) Int. Cl. G06F 40/166; G06F 40/106; G06F 40/143

(52) U.S. Cl. CPC G06F 40/166; G06F 40/106; G06F 40/143

(57) ABSTRACT

Illustrative embodiments simplify creating and/or editing hierarchical markup language code by converting hierarchical markup language code into a graphical format in a graphical user interface that graphically communicates elements of code to a user of the graphical user interface.

### FIELD

Illustrative embodiments of the invention generally relate to computer programming and, more particularly, various embodiments of the invention relate to computer programming interfaces.

### BACKGROUND

A markup language is a text-encoding system consisting of a set of symbols included in the content of a document to control the document's structure, formatting, and/or the relationship between its parts.

Each markup language is defined by a set of rules governing what markup information may be included in a document and how it is combined with the content of the document in a way to facilitate use by humans and computer programs. Some markup languages permit intermingling markup elements (e.g., tags) with document content such as text and images.

Markup language documents can be difficult to create and edit.

For example, a developer may have to edit large complex XAML documents with potentially thousands of lines of markup code. The XAML code can have many dependencies between individual attributes on elements in the markup and may also reference elements and resources in external files.

Just the visual noise alone can be overwhelming even for the most experienced developer. Add to that the need to manage interdependencies within a large document or references to external documents and this makes the task of development and maintenance even more difficult.

### SUMMARY OF VARIOUS EMBODIMENTS

In accordance with one embodiment of the invention, a computer-implemented method for providing a graphical user interface for editing lines of hierarchical markup language code includes:
accessing the lines of hierarchical markup language code, the hierarchical markup language code comprising a plurality of elements, each element comprising a corresponding subset of lines from the hierarchical markup language code, the plurality of elements having a predetermined order within the hierarchical markup language code;
parsing the lines of hierarchical markup language code into the plurality of elements;
generating a plurality of graphical devices, each graphical device uniquely corresponding to a corresponding element of the plurality of elements and representing its corresponding element, each graphical device selectable by a user; and
generating a graphical user interface for display on a computer display, the graphical user interface comprising the plurality of graphical devices arranged in the predetermined order of the elements.

In some embodiments, the method further includes receiving, from the user, selection of a graphical device, said graphical device being a selected graphical device; and in response to receiving such selection, updating the selected graphical device to display its corresponding set of lines from the lines of hierarchical markup language code.

In some embodiments, the method further includes receiving, from the user at the selected graphical device, edits to at least one line of the lines of code associated with the element represented by the selected graphical device.

In some embodiments, wherein for a given element corresponding to a given graphical device from the plurality of graphical devices, the given element has an associated property; and wherein the graphical user interface includes an associated properties graphical panel configured to display the associated property.

In some embodiments, wherein for a given element corresponding to a given graphical device from the plurality of graphical devices, there exists a set of properties available and configured to be associated with the given element, but which properties are not associated with the given element, the graphical user interface includes:
an available properties graphical panel configured to display properties that are available and configured to be associated with the given element but which properties are not associated with the given element.

In some embodiments, wherein a given element of the plurality of elements has an associated bound property, which bound property is specified by a source, said element being a specified element, the graphical user interface includes:
a first graphical device representing the specified element; and
a second graphical device distinct from the first graphical device, the second graphical device representing the source of the bound property; and
a graphical link graphically connecting the first graphical device and the second graphical device to graphically indicate the source of the associated bound property.

In some embodiments, wherein at least a first element from the plurality of elements is bound to a set of second elements from the plurality of elements by a set of property bindings and resource references, the graphical user interface includes: a graphical filter device configured to be activated by the user and that, when activated by the user, causes the graphical user interface to show the first element and the set of second elements.

In some embodiments, wherein a target element from the plurality of elements has a set property that is bound to another element property, said another element property specified by a property source, the graphical user interface includes:
a first graphical device representing the target element and a second graphical device representing the property source; and
a graphical element graphically linking the target element to the property source.

In some embodiments, wherein a target element from the plurality of elements has a property that is bound to a specified resource, the graphical user interface comprises:
a first graphical device representing the target element and a second graphical device representing the specified resource; and
a graphical element graphically linking the target element to the specified resource.

In some embodiments, wherein a target element from the plurality of elements inherits a property from a property source through a set of other elements within a hierarchy of elements within the predetermined order, the graphical user interface includes:
a target graphical device representing the target element and a set of second graphical devices representing elements in the hierarchy of elements; and
a graphical element graphically linking the target element to a source graphical device representing the property source, said graphical element graphically running through the set of other elements within the hierarchy to indicate that said other elements within the hierarchy inherit the property.

Another embodiment includes a computer-implemented system for presenting a graphical user interface for editing lines of hierarchical markup language code, the hierarchical markup language code including a plurality of elements, each element including a corresponding subset of lines from the hierarchical markup language code, the plurality of elements having a predetermined order within the hierarchical markup language code. In such an embodiment, the system includes:
a parser configured to parse the lines of hierarchical markup language code into the plurality of elements;
a graphical device generator configured to generate a plurality of graphical devices, each graphical device uniquely corresponding to a corresponding element of the plurality of elements and representing its corresponding element, each graphical device selectable by a user and configured to display its corresponding set of lines from the lines of hierarchical markup language code in response to being selected by the user; and
a graphical user interface generator configured to generate a graphical user interface for display on a computer display, the graphical user interface comprising the plurality of graphical devices arranged in the predetermined order of the elements.

In some embodiments, the graphical user interface generator is further configured: to receive selection, by the user, of a graphical device from the plurality of graphical devices, said graphical device being a selected graphical device; and to receive from the user, at the selected graphical device, edits to the lines of hierarchical markup language code associated with the element represented by the selected graphical device.

In some embodiments, wherein a given element corresponding to a given graphical device from the plurality of graphical devices has an associated property, generating a graphical user interface for display on a computer display comprises generating a graphical display that includes:
an associated properties graphical panel configured to display the associated property.

In some embodiments, wherein a given element of the plurality of elements has an associated bound property, which bound property is specified by a source, said element being a specified element, the graphical user interface includes:
a first graphical device representing the specified element; and
a second graphical device distinct from the first graphical device, the second graphical device representing the source of the bound property; and
a graphical link graphically connecting the first graphical device and the second graphical device to graphically indicate the source of the associated bound property.

In some embodiments, wherein a target element from the plurality of elements inherits a property from a property source through a set of other elements within a hierarchy of elements, the graphical user interface includes:
a target graphical device representing the target element and a set of second graphical devices representing elements in the hierarchy of elements; and
a graphical element graphically linking the target graphical device to a source graphical device representing the property source, said graphical element graphically running through the set of other elements within the hierarchy to indicate that said other elements within the hierarchy inherit the property.

Illustrative embodiments of the invention are implemented as a computer program product having a computer usable medium with computer readable program code thereon. The computer readable code may be read and utilized by a computer system in accordance with conventional processes.

Yet another embodiment includes a non-transitory computer readable medium having computer-executable code stored thereon, the computer-executable code, when executed by a computer, configured to cause the computer to execute a method that includes:
accessing the lines of hierarchical markup language code, the hierarchical markup language code comprising a plurality of elements, each element comprising a corresponding subset of lines from the hierarchical markup language code, the plurality of elements having a predetermined order within the hierarchical markup language code;
parsing the lines of hierarchical markup language code into the plurality of elements;
generating a plurality of graphical devices, each graphical device uniquely corresponding to a corresponding element of the plurality of elements and representing its corresponding element, each graphical device selectable by a user; and
generating a graphical user interface for display on a computer display, the graphical user interface comprising the plurality of graphical devices arranged in the predetermined order of the elements.

In some embodiments, the method further includes: receiving, from the user, selection of a graphical device, said graphical device being a selected graphical device; and in response to receiving such selection, updating the selected graphical device to display its corresponding set of lines from the lines of hierarchical markup language code.

In some embodiments, wherein a given element corresponding to a given graphical device from the plurality of graphical devices has an associated property; and wherein the graphical user interface includes:
an associated properties graphical panel configured to display the associated property.

In some embodiments, wherein for a given element corresponding to a given graphical device from the plurality of graphical devices, there exists a set of properties available and configured to be associated with the given element, but which properties are not associated with the given element; and the graphical user interface includes an available properties graphical panel configured to display properties that are available and configured to be associated with the given element but which properties are not associated with the given element.

In some embodiments, wherein a target element from the plurality of elements has a set property that is bound to another element property, said another element property specified by a property source, the graphical user interface includes:
a first graphical device representing the target element and a second graphical device representing the property source; and
a graphical element graphically linking the target element to the property source.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically illustrates an embodiment of a system according to one or more embodiments described herein;

FIG. 2 schematically illustrates an embodiment of a markup language code in a markup language document;

FIG. 3A and FIG. 3B schematically illustrate an embodiment of markup language code in a sample markup document;

FIG. 4A is a flowchart that illustrates an embodiment of a method of generating a graphical user interface from content of a markup language document;

FIG. 4B further specifies an embodiment of a method of generating a graphical user interface;

FIG. 5A schematically illustrates an embodiment of a graphical user interface;

FIG. 5B schematically illustrates an embodiment of a graphical user interface;

FIG. 5C schematically illustrates an embodiment of a graphical user interface;

FIG. 5D schematically illustrates an embodiment of a graphical user interface;

FIG. 5E schematically illustrates an embodiment of a graphical user interface;

FIG. 6 schematically illustrates an embodiment of a system for generating a graphical user interface.

### DETAILED DESCRIPTION OF ILLUSTRATIVE EMBODIMENTS

Illustrative embodiments simplify creating and/or editing code, including hierarchical markup language code, by converting complex code into a graphical format in a graphical user interface that graphically communicates elements of code to a user of the graphical user interface.

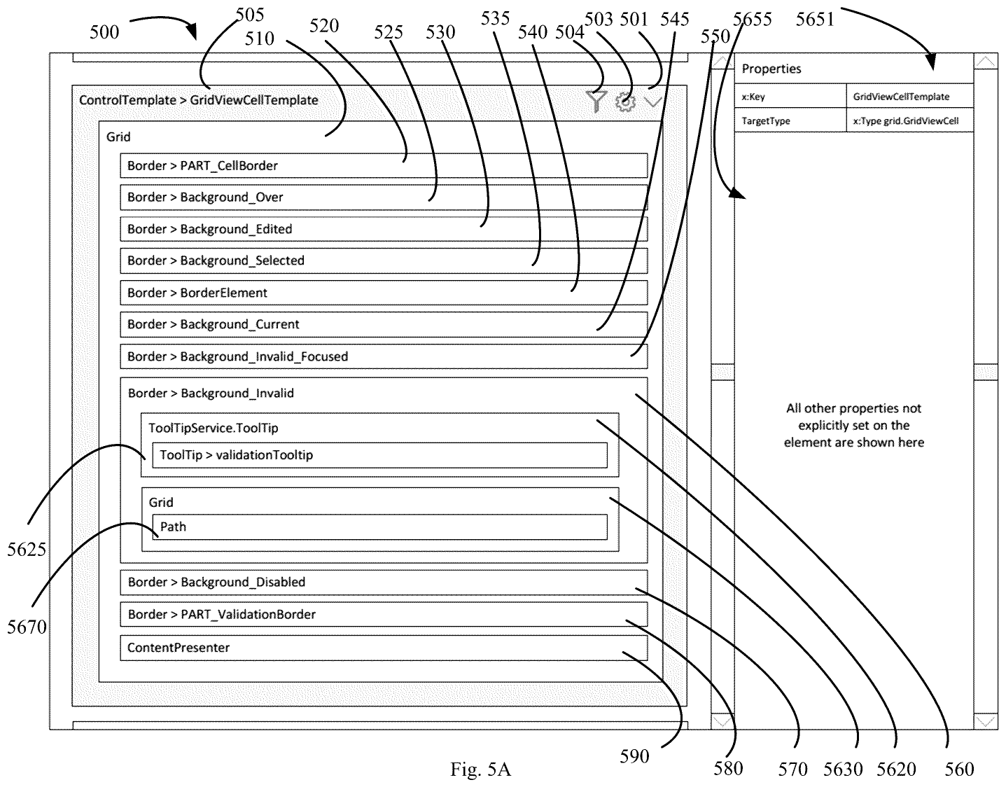

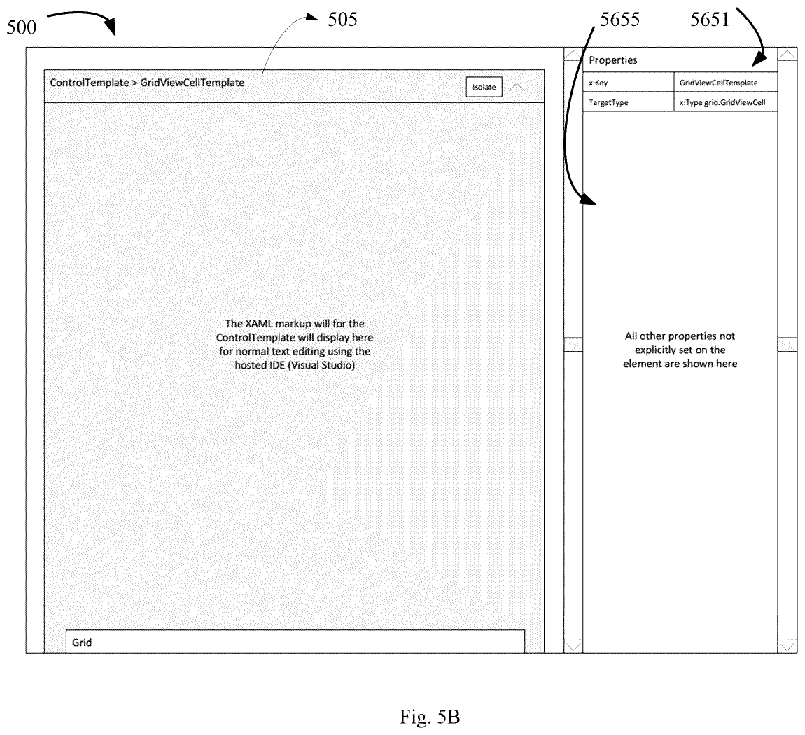

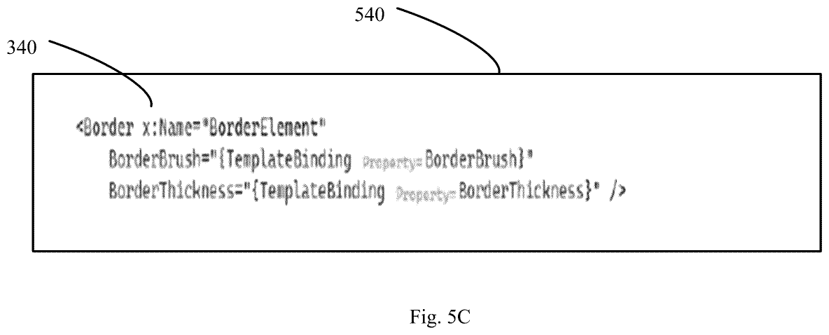

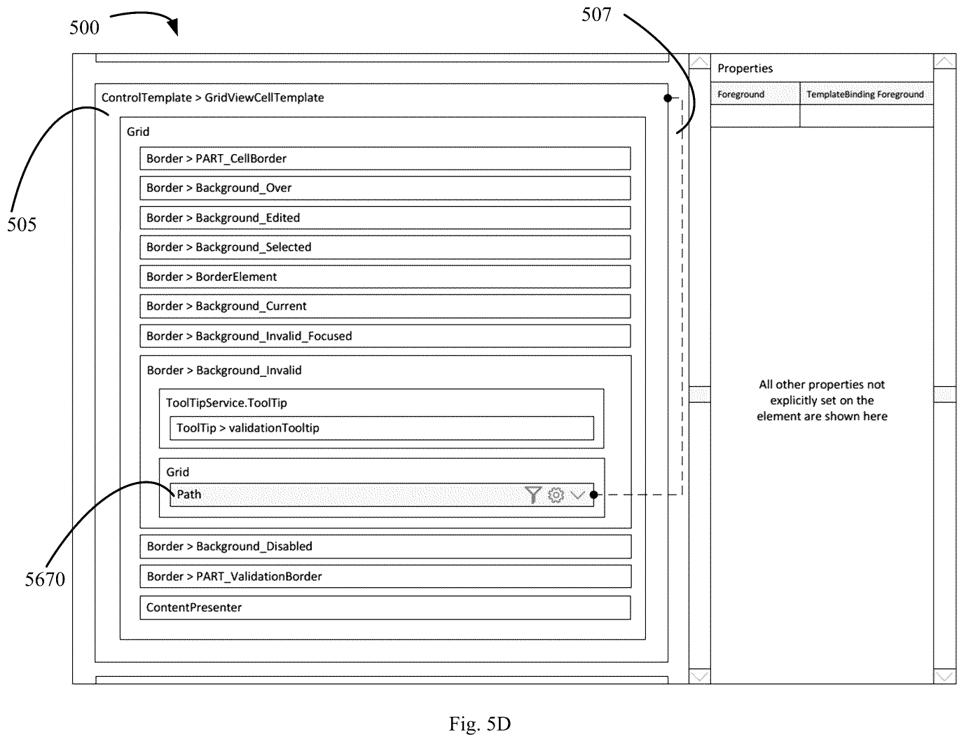

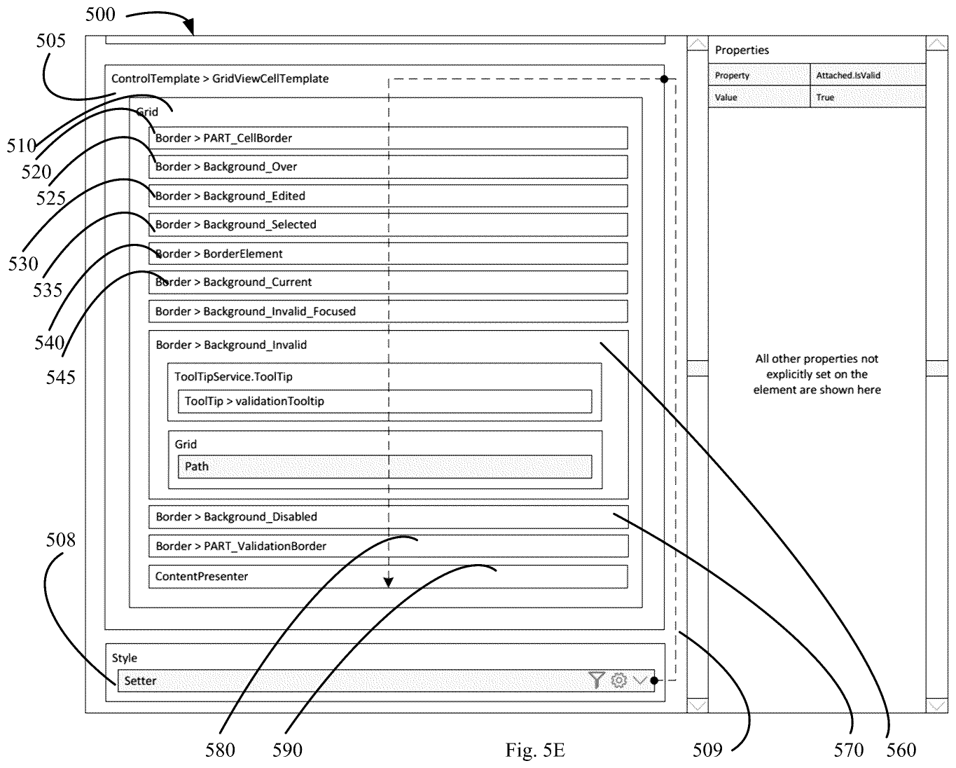

For example, illustrative embodiments take a large complex XAML document and simplify it into a geometric visualization. This makes it easier for a developer to understand and navigate the structure without getting overwhelmed. Selecting a rectangle will display the element's properties in a side panel 5650. Properties that are directly set on the element are displayed first, followed by all available properties. Geometric elements can be configured to show user-selected information in the element's header. A default, in some embodiments, show the element's Name or Key properties. This can be done through a global settings button or an element specific settings button 503, (schematically illustrated in FIG. 5A with a “gear” icon on the selected element)

XAML documents, and some other markup language documents, can have dependencies between elements via property bindings and resource references. The geometric view can be filtered to show only the current element, it's children, and related elements with a single filter toggle button. This can help a developer focus on a subset of the document taking potentially thousands of elements and filtering it down to a handful for editing.

While embodiments may be illustrated in a specific hierarchical markup language, illustrative embodiments can apply to many hierarchical markup languages (XML, YAML, JSON, etc.), including both compiled markup languages (such as XAML, including features such as dependency properties and attached properties, etc.) and non-compiled markup such as XML or JSON, to name but a few examples.

Illustrative embodiments present improvements over conventional user interfaces for creating and editing markup language code by providing a graphical user interface that simplifies creating and/or editing code, including hierarchical markup language code such as XML code, YAML code, JSON code, or XAML code, to name but a few examples.

Definitions: As used in this description and the accompanying claims, the following terms shall have the meanings indicated, unless the context otherwise requires.

The term “computer-implemented” means implemented with hardware or a combination of hardware and software. Such hardware may include, without limitation, a set of one or more computer processors (e.g., circuits such as a microprocessors, digital signal processors) configured to execute computer-executable code, application specific integrated circuits (“ASICs”), discrete electronic circuits (e.g., transistors), state machine circuits, sequential logic circuits, and/or combinatorial logic circuits, or any combination of the foregoing hardware. Such computer hardware may be in a single computer (e.g., a server), or may be distributed across a plurality of locations over a network (e.g., the “cloud,” as that term is understood in the field of distributed computing).

A “delimiting” feature of markup code is a feature within the code that is recognizable by a parser, or a parsing operation, to enable the parser or parsing operation to identify an element in the code and distinguish such element from other elements. In illustrative embodiments, tags are delimiting features.

An “element” (or “segment”) in a markup language document is a distinct portion or sub-portion of the content of the markup language document. Various markup language may describe an element using specified terms. For example, JSON uses the term “object.” In some markup languages, an element may identified by a start tag, which start tag identifies the location within the content of a markup document at which the content of the element begins. In some markup languages, an element is identified by a start tag and an end tag, which end tag identifies the location within the content of a markup document at which the content of the element ends.

In some embodiments, an element includes a “property binding.” In such embodiments, the element include a placeholder for content to be specified a runtime. At runtime, a method or system will find a property that specifies the content, and supply that content to a function that will consume that content. The property may specified in a different element in the code, or in a remote system executing a method. For example, in the XAML markup language, a property binding in markup up code may look like this:
“<TextBlock Text=” {Binding GreetingText}”/>”

At runtime, the TextBlock which displays text will look for a property named GreetingText and will use that for the Text. If Greeting Text was “Hello Newman!” then at runtime the TextBlock would look like this:
“<TextBlock Text=” Hello Newman!”/>”

In some embodiments, an element includes a “resource reference” as a placeholder for one or more aspects of content. The aspect of content may specified in a different element in the code, or in a system executing a method For example, in the XAML markup language, a resource reference in markup code may look like this:

“<TextBlock Foreground=”{DynamicResource TextColor}”
Text=”Hello Oldman!” />”

In this case, the method or system looks through the application's resources (e.g., which is an internal database of data, or an external data source, such as a computer data store in the cloud 120, or in a database 130) and looks for a resource named TextColor which should be a color. In an example in which a resource reference specifies that associated text is to be displayed in black font [i.e., “{DynamicResource TextColor}” is “Black”], at runtime the element would look like this:
“<TextBlock Foreground=“Black” Text=“Hello Oldman!”/>”

A “graphical” display is a computer display format that presents at least some information in graphical form. Display of data in alpha-numeric form (e.g., text) alone is not a graphical display, even if the alpha-numeric data (e.g., text) is in a table or spreadsheet format. Text or code is not a graphical format merely because some of the text or code is indented from other text or code.

The term “graphical user interface” (or “GUI”) means a form of computer-user interface that allows users to interact with a computer at least in part through graphical devices displayed on a computer display screen. Examples of graphical devices may include a graphical icon, a menu (including a drop-down menu), a window, and a pane, to name but a few examples. A data entry area (e.g., a rectangle) that is configured to receive alpha-numeric input from a user (e.g., where the alpha-numeric input is solicited by such other graphical device) is also an example of a graphical device. A command-line, and a text editor, without more, is not a graphical user interface.

A “set” includes at least one member. For example, a set of lines of markup code may include as few as a single line, or may include a plurality of lines.

A “tag” (or “markup tag”) in reference to a markup document, is a markup instruction defined by the specification for the markup language with which the markup document complies. For example, in some markup languages, a tag includes text enclosed between brackets, such as angle brackets. In some markup languages, a tag includes only a single bracket (e.g., a single angle bracket), sometimes with one or more additional characters adjacent to the single bracket. A tag is capable of delimiting segments of a markup language document in such a way that a parser can parse the segments by analyzing the document's tags.

For example, XML-based languages have start tags that begin with “<” and end with “>” and end tags that start with “</” and end with “>”. One exception is a self-closing tag that starts with “<” and ends with “/>”.

JSON on the other hand uses “{” and “}” to denote an object, and “[” and “]” to denote an array of objects. For example, JSON uses segments called “objects,” of which the following is an example, in which an object is delimited by brackets”{“and}”:

```
“{
  “FirstName”: “Charles”,
  “LastName”: “Proteus”,
  “Clients”: [
      {
        “FirstName”: “Henry”,
        “LastName”: “Ford”,
        “Company”: “FMC”
      }
    ]
}”
```

In the foregoing example, a second object named “Clients” is nested within the first object, delimited by corresponding brackets. In the foregoing example, the code can be parsed by assessing the brackets.

Some markup languages define tags for semantic markup (i.e., semantic markup tags that describe the intended purpose or the meaning of the text they include), and some markup languages define tags for presentation markup (e.g., to specify a particular characteristic of the text without specifying the reason for that appearance). Some markup languages allow users to define tags not specified in the respective specifications for the markup language.

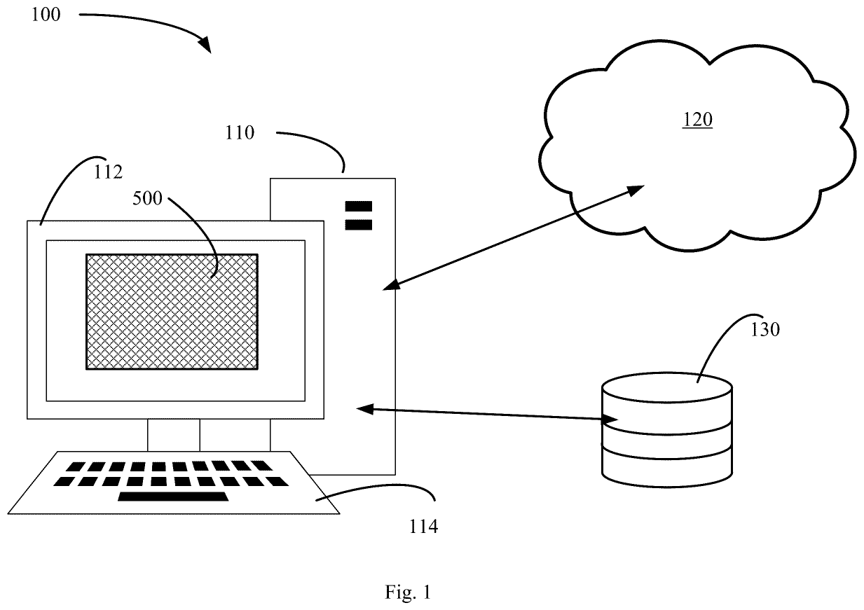

FIG. 1 schematically illustrates an embodiment of a system 100 according to one or more embodiments described herein. The system 100 includes a computer 110 having a computer processor, such as a microprocessor as known in the semiconductor arts. The computer 100 may have a display device 112 configured to receive and display one or more generated images (e.g., a graphical user interface). The display device is configured to display a graphical user interface 400. In some embodiments, the display device 112 may be configured to receive user input, for example such as tactile user input on a touchscreen. Some embodiments of the computer include a keyboard 114 and/or mouse configured to receive user input, as known in the computing arts.

In some embodiments, the computer 110 may be part of a computer system in the cloud 120, as that term is known in the computing arts, and may be in data communication with other computers in the cloud 120. In some embodiments, the computer may be data communication with a database 130.

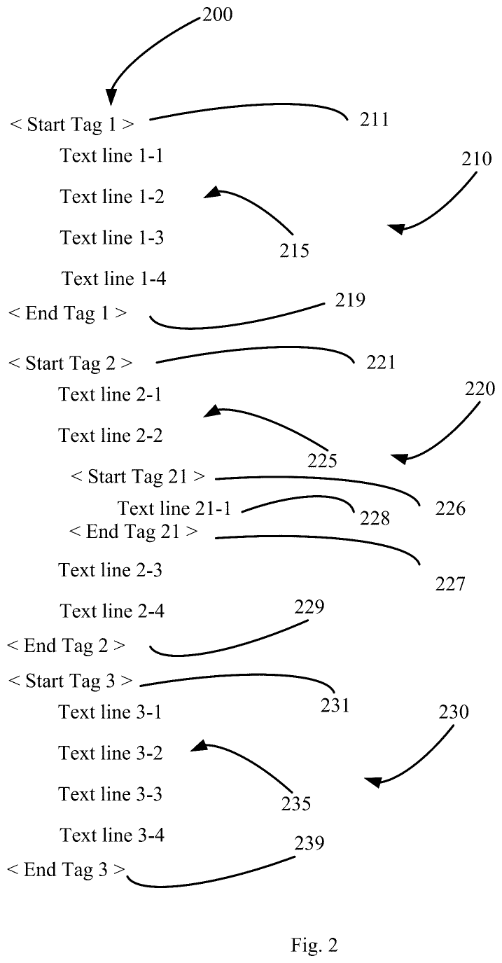

FIG. 2 schematically illustrates an embodiment of content 200 of a markup language document. The content 200, which may be referred-to as “code” or “markup language code” as that term is used in the field of markup languages, includes several elements, or segments, 210, 220, 230 of text, each element is delimited by one or more tags. The content 200 illustrated in FIG. 2 is not in a graphical format, and its display on a display device would not be a graphical display.

The several elements 210, 220, 230 have a predetermined order within the hierarchical markup language code 200. Element 220 has a nested element delimited by Start Tag 21 (reference number 226) and End Tag 21 (reference number 227), and include a line of markup language code (reference number 228). The nested element may be referred to as “hierarchical” element, and the markup language code may be referred-to as having a “hierarchical” order, and the code 200 may be referred-to as “hierarchical markup language code.”

The following is an example of a simple hierarchy:

```
“<Border>
  <Grid>
    <ContentPresenter />
  </Grid>
</Border>”
```

In the foregoing example, the ContentPresenter is nested inside a Grid, which is nested inside a Border. In many hierarchical markup languages, including at least XAML, XML, and JSON, hierarchical markup language can may have many levels of nesting.

That organization is different from a linear order:

“<Border />
<Grid />
<ContentPresenter />”

A markup language document can have both hierarchical nesting and linear order of elements in a single document, but if code in a document has at least one element nested within another element, the code may be described as “hierarchical markup language code.”

Each markup language defines tags (e.g., structures that delimit elements).

A first element 210 is defined in part by a start tag (Start Tag 1) 211 at the beginning of the element 210, and by an end tag (End Tag 1) 219 at the end of the element 210. The element also includes lines of text 215 disposed between the start tag 211 and the end tag 219. The start tag 211 and the end tag 219 delimited (i.e., define the boundaries of) the first element 210.

A second element 220 is delimited by start tag 221 and end tag 229, and includes lines of text 225.

A third element 220 is delimited by start tag 231 and end tag 239, and includes lines of text 235.

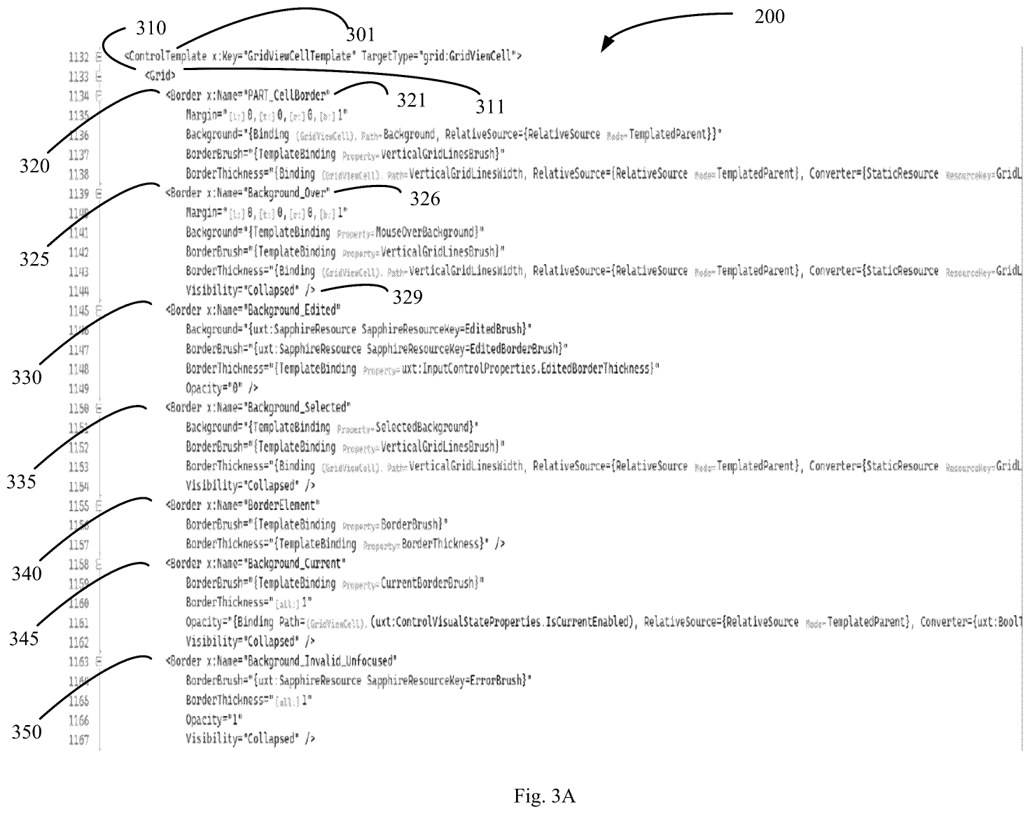

FIG. 3A and FIG. 3B schematically illustrate an embodiment of content 300 of a sample markup document. The content 300 shown in FIG. 3A and FIG. 3B is not in a graphical format, and its display on a display device would not be a graphical display. The content 300 is markup language code, and the elements in that code have a predetermined order. Further, as described below, some elements have child elements nested within them. The order of the elements and their child elements define the “hierarchical” order of the code, and so the code 200 may be referred-to as “hierarchical markup language code.”

In the example of FIG. 3A and FIG. 3B, the content 300 is markup document (or markup code) and is captioned “GridViewCellTemplate” as indicated by tag 301.

The content 300 includes a plurality of elements 305, 310, 320, 325, 330, 335, 340, 345, 350 illustrated in FIG. 3A, and elements 360, 370, 380 and 390 in FIG. 3B (although only a portion of element 390 is illustrated in FIG. 3B).

The content 300 includes an element 310 captioned “Grid” with a start tag 311.

The content 300 includes an element 320 captioned “Part_CellBorder” with a start tag 321 and an end tag 324, and several lines of text disposed between start tag 321 and end tag 324 (not shown in FIG. 3A).

The content 300 includes an element 325 captioned “Background_Over” with a start tag 326 and an end tag 329, and several lines of text disposed between start tag 321 and end tag 329 (not shown in FIG. 3A).

Element 360 is captioned “Background_Invalid” and is delimited by start tag 361 and end tag 369.

Element 360 includes several elements nested within element 360. An element nested within a first element may be referred-to as “child” of the first element.

The first nested element 3620 is captioned “ToolTipService.ToolTip” and is delimited by start tag 3621 and end 3623.

The first nested element 3620 includes a second nested element 3625 captioned “ValicationTooltip” delimited by start tag 3626 and end tag 3629. Second nested element 3625 includes content lines 329.

A third nested element 3630 is captioned “Grid” and is delimited by start tag 3631 and end tag 3633, with content lines 3632 disposed between tag 3631 and end tag 3633.

Also disposed within (i.e., nested within) the third nested element 3630 is a fourth nested element 3670, captioned “Path,” which is delimited by start tag 3671 and end tag 3673, and which include content lines 3672 disposed between start tag 3671 and end tag 3673.

Embodiment of methods and systems disclosed herein create and operate a graphical user interface (“GUI”) based on the content of a markup document.

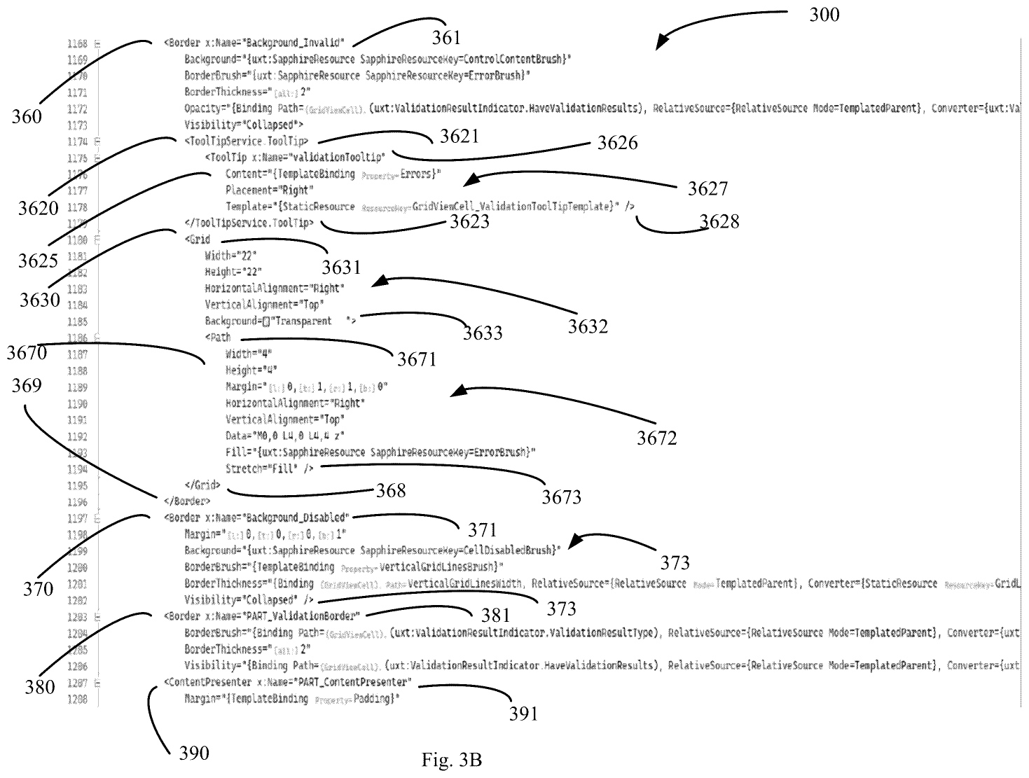

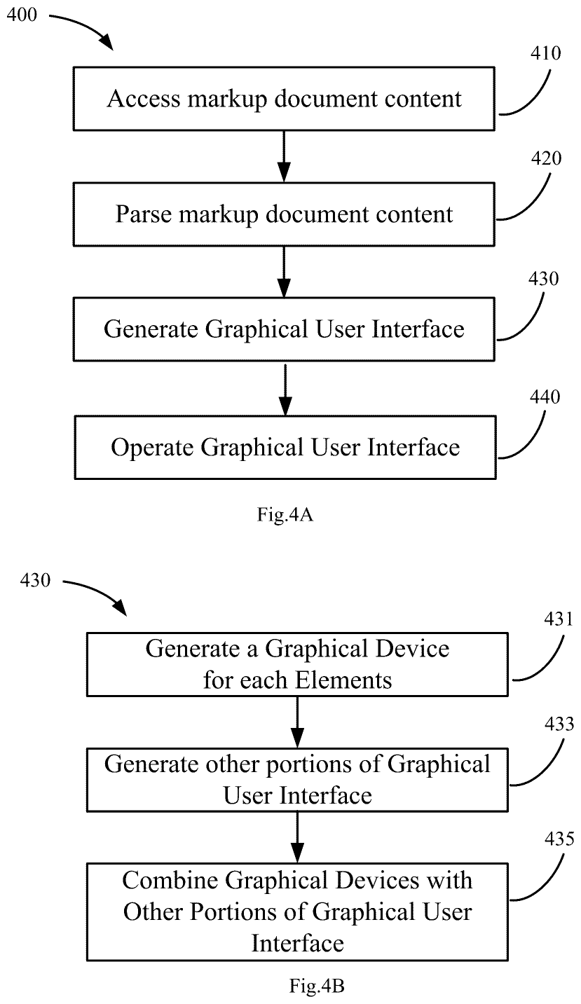

FIG. 4A is a flowchart that illustrates an embodiment of a method 400 of generating a graphical user interface from content of a markup document. FIG. 4B further specifies an embodiment of a method of generating a portion of a graphical user interface.

Illustrative embodiments of the method 400 can create a graphical user interface 400 from the content 200 of FIG. 2. As just one illustration, the method 400 can create a graphical user interface of any of FIG. 5A, FIG. 5B, FIG. 5C, FIG. 5D and FIG. 5E from the content 300 of FIG. 3A and FIG. 3B.

At step 410, the method 400 accesses the code 200 of a markup language document. The hierarchical markup language code 200 includes a plurality of elements, and each element includes a corresponding subset of lines from the hierarchical markup language code. The plurality of elements have a predetermined order within the hierarchical markup language code.

The content of the markup language document may be stored in a memory 620 of a computer system, or in a computer storage in the cloud 120, or in a database 130.

At step 420, the method 400 includes parsing the markup language code 200 to identify individual elements (e.g., 210, 220, 230, 305 310, 320, 325, 330, 335, 340, 345, 350, 360, 3620, 3630, 3670, 370, 380, 390) within that markup language code. In illustrative embodiments, step 402 parses the markup language code to identify individual elements within the code by identifying tags (e.g., start tags; end tags) within the code.

At step 430, the method 400 includes generating a graphical user interface for display on a display device.

In illustrative embodiments, as illustrated in FIG. 4B, generating a graphical user interface for display on a display device includes, at step 431, generating a plurality of graphical devices, each graphical device uniquely corresponding to a corresponding element of the plurality of elements and representing its corresponding element. Such a graphical device may be a rectangle, as schematically illustrated in FIG. 5A, for example, or may be a graphical element having a shape other than a rectangle (e.g., an ellipse).

FIG. 5A schematically illustrates an embodiment of a graphical user interface 500 generated by method 400 based on the code of FIG. 3A and FIG. 3B. The graphical user interface 500 includes several graphical devices, wherein each such graphical device corresponds to an element of code in FIG. 3A and FIG. 3B. The correspondence between elements of code in FIG. 3A and FIG. 3B and graphical devices in the graphical user interface of FIG. 5A is set forth in the following listing:

| Code | Graphical |
|---|---|
| Element | Device |
| 310 | 510 |
| 320 | 520 |
| 325 | 525 |
| 330 | 530 |
| 335 | 535 |
| 340 | 540 |
| 345 | 545 |
| 350 | 550 |
| 360 | 560 |
| 3620 | 5620 |
| 3625 | 5625 |
| 3630 | 5630 |
| 3670 | 5670 |
| 370 | 570 |
| 380 | 580 |
| 390 | 590 |

In illustrative embodiments, each graphical device selectable by a user.

At step 433, the method 400 includes generating other portions or components of the graphical user interface, such as an available properties graphical panel 5655 as schematically illustrated in FIG. 5A, and/or an associated properties graphical panel 5651 as schematically illustrated in FIG. 5A, to name but a few examples.

For example, in some embodiments in which given element, corresponding to a given graphical device from the plurality of graphical devices, has an associated property, the graphical user interface includes an associated properties graphical panel 5651 (FIG. 5A) configured to display the associated property. A parser, and a parsing method, assesses markup language code to identify bound properties and available properties.

In some embodiments, in which a given element corresponds to a given graphical device from the plurality of graphical devices, there exists a set of properties available and configured to be associated with the given element, but which properties are not associated with the given element, and the graphical user interface includes an available properties graphical panel 5655 (FIG. 5A) configured to display properties that are available and configured to be associated with the given element but which properties are not associated with the given element.

At step 435, the method 400 the method includes combining the generated graphical devices from step 431 with the generated other portions of the graphical user interface from step 433, to produce an integrated graphical user interface. In illustrative embodiments, the graphical devices are arranged in the predetermined order of the elements.

An illustrative embodiment of an integrated graphical user interface 500, based on the code of FIG. 3A and FIG. 3B, is schematically illustrated in FIG. 5A. The integrated graphical user interface 500 includes a plurality of graphical devices generated at step 431, wherein each graphical device corresponds to an element of code from the code illustrated in FIG. 3A and FIG. 3B. An element (e.g., 360) that has one or more nested elements (e.g., 3620 and 3630) produces a corresponding graphical device (e.g., 560) with one or more corresponding nested graphical devices (e.g., 5620 and 5630, respectively).

At step 440, the method 400 includes operating the graphical user interface 500. In illustrative embodiments, operating the graphical user interface includes one or more of receiving user input via the graphical user interface and changing the graphical user interface in response to receiving user input. In illustrative embodiments, the graphical user interface is configured to receive selection, by a user, of one or more graphical devices; displaying in a selected graphical device the markup language code associated with that selected graphical device; and/or receiving user edits to markup language code displayed in a selected graphical device.

Some embodiments of method 400 include receiving, from the user, selection (or activation) of a code-display graphical control element or icon (e.g., chevron 501 in FIG. 5B), and in response to receiving such selection, updating the selected graphical device to display its corresponding set of lines from the lines of hierarchical markup language code. Such an embodiment is schematically illustrated in FIG. 5B. The graphical control element 501 may be referred-to as a “contextual expander,” that reveals the markup code from its associated element. In illustrative embodiments, said markup code can be edited by the user, within the graphical user interface 500, and specifically within the graphical device associated with the markup code. When finished, the user can select the graphical control element 501 again, and the text will disappear and be replaced by its associated graphical element.

Illustrative embodiments of method 400 include receiving, from the user, selection of a graphical device, said graphical device being a selected graphical device; and in response to receiving such selection, updating the selected graphical device to display its corresponding set of lines from the lines of hierarchical markup language code, is schematically illustrated in FIG. 5C. As schematically illustrated in FIG. 5C, a user has selected graphical device 540, which corresponds to element 340 in FIG. 3A. In response, the method and system generate, or update, graphical device 540 to include display of the code of element 340.

Some embodiments include receiving, from the user at the selected graphical device, edits to at least one line of the lines of code associated with the element represented by the selected graphical device.

Some embodiments of markup language code include placeholder or links to resources that specify a content and/or quality of an element, such as a property binding (or “bound” property) and a resource reference. Some such embodiments may include a link (e.g., 507, 509) between one element (e.g., an element with such a placeholder or link) and an associated resource, whether that associated resource is within the markup language code, or elsewhere (e.g., in memory 620; database 130; and/or at a data storage resource in the cloud 120). Some illustrative examples are described below. Such a link represents an improvement over conventional user interfaces in that it allows a user to more easily identify an element that is bound to another element, or that receives a property or content from a resource external to the element. For example, if a user edits an element that receives specification of a content and/or quality of the element from a source external to that element, the user may need to know the source of that specification, and a link as described herein enables the user to more easily identify that source. Also for example, if a source external to a set of elements specifies a content and/or quality of those elements, such as when those elements inherit said content and/or quality from that source, as user may desire to know the identity of that source, for example if the user wants to change such content or quality at the source. In some embodiments, in which the user wants to edit said source, the user may want to know before editing which elements inherit from that source, so as to understand the impact on those inheriting elements of the user's edits to the source. In such situations, a link as described herein enables the user to more easily identify that source.

In some embodiments, a given element of the plurality of elements (which given element may be referred-to as a specified element) has an associated bound property, which bound property is specified by a source (e.g., another element within the code). In practice, this means that when the property is changed at the source, the same change occurs at the property of the given element. In such embodiments, this means that a user may edit a property at a source, and that property will propagate to an element to which that property is bound.

In some such embodiments, as schematically illustrated in FIG. 5D, graphical user interface includes (a) a first graphical device representing the specified element; and (b) a second graphical device distinct from the first graphical device, the second graphical device representing the source of the bound property; and (c) a graphical link 507 graphically connecting the first graphical device and the second graphical device to graphically indicate the source of the associated bound property. For example, the graphical link 507 may be a line, a dashed line, a dotted line, a curve, etc.

For example, FIG. 5D schematically illustrates an embodiment in which the element represented by graphical device 5670 is the source (e.g., a “specified resource”) of a bound property for element 505. Graphical link 507 graphically connects graphical device 5670 to element 505, thereby indicating to a user viewing the graphical user interface 500 that graphical device 5670 is the source of a bound property for element 505.

In this embodiment, the graphical link 507 communicates to the user that the Foreground property of the Path is bound to the Foreground property of the parent template. In this example, that is the ControlTemplate block. The term “bound” it means that anytime the Foreground property changes on the ControlTemplate, it will be automatically updated on the Path. These bindings can be created in different ways between any two blocks as long as they exist in the same hierarchy.

In some embodiments (e.g., some XAML documents), a plurality of elements inherit a property through one another, from an external property source (i.e., a source external to the markup language document).

For example, FIG. 5E schematically illustrates an embodiment in which graphical device 508 represents an element that is the source (e.g., a “specified resource”) of a property for element 505, and element 510 via element 505, and element 520 via element 510, etc. Graphical link 509 graphically connects graphical device 508 to element 505, and then to element 510 via element 505, and then to element 520 via element 510, and to all elements through which graphical link 509 runs, thereby indicating to a user of the graphical user interface 500 that that graphical device 508 is the source of a property for element 505, and elements 510, 520, 525, 530, 535, 540, 545, 550, 560, 5620, 5625, 5630, 5670, 570, 580 and 590, i.e., all elements through which graphical link 509 passes. The graphical link 509 may be referred-to as an “inheritance” link. For example, the inheritance link 509 may be a line, a dashed line, a dotted line, a curve, etc.

In some embodiments in which at least a first element from a plurality of elements is bound to a set of second elements from the plurality of elements by a set of property bindings or resource references, the graphical user interface includes a graphical filter device 504 configured to be activated by the user and that, when activated by the user, causes the graphical user interface to show the first element and the set of second elements.

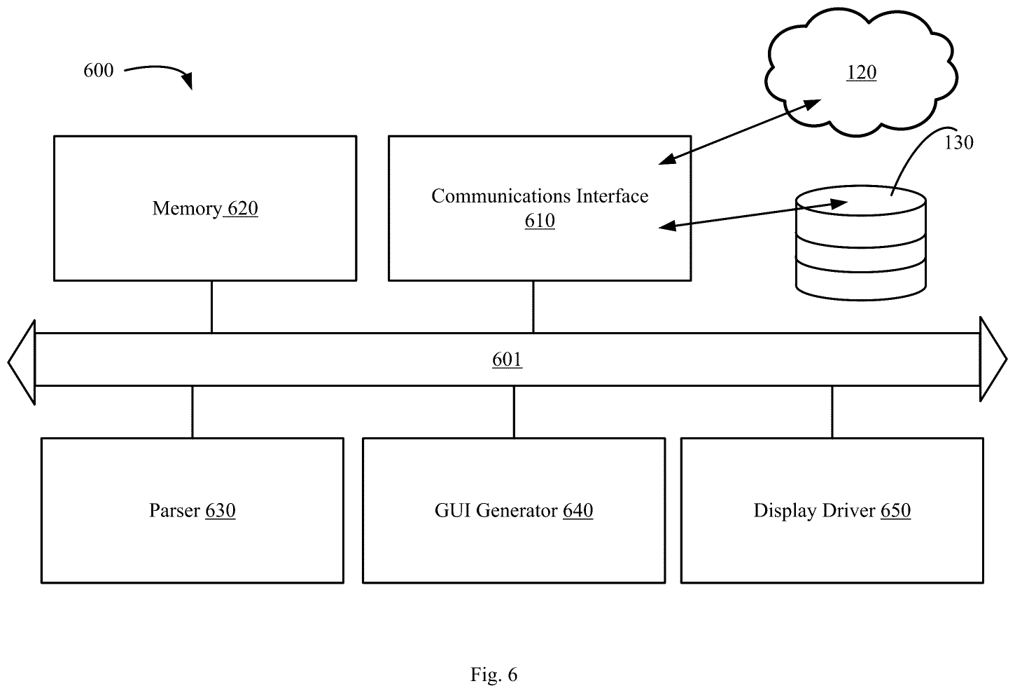

FIG. 6 schematically illustrates an embodiment of a system 600 for generating a graphical user interface.

The system 600 includes a plurality of modules in data communication with each other over a network 601. Some embodiments of the system 600 may be implemented on a computer, such as computer 110 for example. Some embodiments may be implemented in whole or in part by resources in the cloud 120.

Some embodiments include an internal communications interface (601) configured to allow modules to communicate with one another, and or an outward-facing communications interface 610 to allow the system 600 to communicate with external resources, such as a computers and data storage in the cloud 120, and/or data stored in a database 130.

Some embodiments include a memory 120, which may be a transient memory or a non-transitory computer readable medium. The memory 120 may have computer-executable code stored thereon, including without limitation markup language code.

Illustrative embodiments of the system 600 include a parser 630 configured to perform parsing operations, as described herein, on markup language code.

Illustrative embodiments of the system 600 include a graphical user interface generator 640 configured to generate features of a graphical user interface, as described herein, and to operate a graphical user interface, as described herein.

Illustrative embodiments of the system 600 include a display driver 650 configured to cause a display device 120 to display a graphical user interface 400. In some embodiments, the display drier 650 is also configured to receive user input via a display device 120, such as when the display device 120 is a touchscreen computer display.

A listing of certain reference numbers is presented below.
100: system overview;
110: computer;
112: computer monitor;
114: keyboard;
120: cloud;
130: database;
500: graphical user interface;
501: code-display graphical control element (or icon);
503: settings graphical control element (or icon);
507: graphical link coupling elements;
508: property source graphical device;
509: inheritance link;
600: system;
601: bus;
610: communications interface module;
620: memory module;
630: parser module;
640: graphical user interface module;
650: display driver module.

Various embodiments may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. A computer-implemented method for providing a graphical user interface for editing lines of hierarchical markup language code, the method comprising:
accessing the lines of hierarchical markup language code, the hierarchical markup language code comprising a plurality of elements, each element comprising a corresponding subset of lines from the hierarchical markup language code, the plurality of elements having a predetermined order within the hierarchical markup language code;
parsing the lines of hierarchical markup language code into the plurality of elements;
generating a plurality of graphical devices, each graphical device uniquely corresponding to a corresponding element of the plurality of elements and representing its corresponding element, each graphical device selectable by a user; and
generating a graphical user interface for display on a computer display, the graphical user interface comprising the plurality of graphical devices arranged in the predetermined order of the elements.
   P2. The computer-implemented method of P1, further comprising:
receiving, from the user, selection of a graphical device, said graphical device being a selected graphical device; and in response to receiving such selection,
updating the selected graphical device to display its corresponding set of lines from the lines of hierarchical markup language code.
   P3. The computer-implemented method of P2, further comprising:
receiving, from the user at the selected graphical device, edits to at least one line of the lines of code associated with the element represented by the selected graphical device.
   P4. The computer-implemented method of any of P1-P3, wherein:
for a given element corresponding to a given graphical device from the plurality of graphical devices, the given element has an associated property; and wherein the graphical user interface comprises:
   an associated properties graphical panel configured to display the associated property.
      P5. The computer-implemented method of any of P1-P4, wherein:
for a given element corresponding to a given graphical device from the plurality of graphical devices, there exists a set of properties available and configured to be associated with the given element, but which properties are not associated with the given element; and wherein the graphical user interface comprises:
   an available properties graphical panel configured to display properties that are available and configured to be associated with the given element but which properties are not associated with the given element.
      P6. The computer-implemented method of any of P1-P5, wherein a given element of the plurality of elements has an associated bound property, which bound property is specified by a source, said element being a specified element, wherein the graphical user interface comprises:
a first graphical device representing the specified element; and
a second graphical device distinct from the first graphical device, the second graphical device representing the source of the bound property; and
a graphical link graphically connecting the first graphical device and the second graphical device to graphically indicate the source of the associated bound property.
   P7. The computer-implemented method of any of P1-P6, wherein at least a first element from the plurality of elements is bound to a set of second elements from the plurality of elements by a set of property bindings and resource references, and the graphical user interface comprises:
a graphical filter device configured to be activated by the user and that, when activated by the user, causes the graphical user interface to show the first element and the set of second elements.
   P8. The computer-implemented method of any of P1-P7, wherein a target element from the plurality of elements has a set property that is bound to another element property, said another element property specified by a property source, and wherein:
the graphical user interface comprises:
   a first graphical device representing the target element and a second graphical device representing the property source; and
   a graphical element graphically linking the target element to the property source.
      P9. The computer-implemented method of any of P1-P8, wherein a target element from the plurality of elements has a property that is bound to a specified resource, and wherein the graphical user interface comprises:
a first graphical device representing the target element and a second graphical device representing the specified resource; and
a graphical element graphically linking the target element to the specified resource.
   P10. The computer-implemented method of any of P1-P9, wherein a target element from the plurality of elements inherits a property from a property source through a set of other elements within a hierarchy of elements within the predetermined order, and wherein the graphical user interface comprises:
a target graphical device representing the target element and a set of second graphical devices representing elements in the hierarchy of elements; and
a graphical element graphically linking the target element to a source graphical device representing the property source, said graphical element graphically running through the set of other elements within the hierarchy to indicate that said other elements within the hierarchy inherit the property.
   P11. A computer-implemented system for presenting a graphical user interface for editing lines of hierarchical markup language code, the hierarchical markup language code comprising a plurality of elements, each element comprising a corresponding subset of lines from the hierarchical markup language code, the plurality of elements having a predetermined order within the hierarchical markup language code, the system comprising:
a parser configured to parse the lines of hierarchical markup language code into the plurality of elements;
a graphical device generator configured to generate a plurality of graphical devices, each graphical device uniquely corresponding to a corresponding element of the plurality of elements and representing its corresponding element, each graphical device selectable by a user and configured to display its corresponding set of lines from the lines of hierarchical markup language code in response to being selected by the user; and
a graphical user interface generator configured to generate a graphical user interface for display on a computer display, the graphical user interface comprising the plurality of graphical devices arranged in the predetermined order of the elements.
   P12. The computer-implemented system of P11, wherein the graphical user interface generator is further configured:
to receive selection, by the user, of a graphical device from the plurality of graphical devices, said graphical device being a selected graphical device; and
to receive from the user, at the selected graphical device, edits to the lines of hierarchical markup language code associated with the element represented by the selected graphical device.
   P13. The computer-implemented system of any of P11-P12, wherein a given element corresponding to a given graphical device from the plurality of graphical devices has an associated property, and
generating a graphical user interface for display on a computer display comprises generating a graphical display that includes:
   an associated properties graphical panel configured to display the associated property.
      P14. The computer-implemented system of any of P11-P13, wherein a given element of the plurality of elements has an associated bound property, which bound property is specified by a source, said element being a specified element, wherein the graphical user interface comprises:
a first graphical device representing the specified element; and
a second graphical device distinct from the first graphical device, the second graphical device representing the source of the bound property; and
a graphical link graphically connecting the first graphical device and the second graphical device to graphically indicate the source of the associated bound property.
   P15. The computer-implemented system of any of P11-P14, wherein a target element from the plurality of elements inherits a property from a property source through a set of other elements within a hierarchy of elements, and wherein the graphical user interface comprises:
a target graphical device representing the target element and a set of second graphical devices representing elements in the hierarchy of elements; and
a graphical element graphically linking the target graphical device to a source graphical device representing the property source, said graphical element graphically running through the set of other elements within the hierarchy to indicate that said other elements within the hierarchy inherit the property.
   P16. A non-transitory computer readable medium having computer-executable code stored thereon, the computer-executable code, when executed by a computer, configured to cause the computer to execute a method, the method comprising:
accessing the lines of hierarchical markup language code, the hierarchical markup language code comprising a plurality of elements, each element comprising a corresponding subset of lines from the hierarchical markup language code, the plurality of elements having a predetermined order within the hierarchical markup language code;
parsing the lines of hierarchical markup language code into the plurality of elements;
generating a plurality of graphical devices, each graphical device uniquely corresponding to a corresponding element of the plurality of elements and representing its corresponding element, each graphical device selectable by a user; and
generating a graphical user interface for display on a computer display, the graphical user interface comprising the plurality of graphical devices arranged in the predetermined order of the elements.
   P17. The non-transitory computer readable medium of P16, wherein the method further comprises:
receiving, from the user, selection of a graphical device, said graphical device being a selected graphical device; and in response to receiving such selection,
updating the selected graphical device to display its corresponding set of lines from the lines of hierarchical markup language code.
   P18. The non-transitory computer readable medium of any of P16-P17, wherein:
for a given element corresponding to a given graphical device from the plurality of graphical devices, the given element has an associated property; and wherein the graphical user interface comprises:
an associated properties graphical panel configured to display the associated property.
   P19. The non-transitory computer readable medium of any of P16-P18, wherein:
for a given element corresponding to a given graphical device from the plurality of graphical devices, there exists a set of properties available and configured to be associated with the given element, but which properties are not associated with the given element; and wherein the graphical user interface comprises:
an available properties graphical panel configured to display properties that are available and configured to be associated with the given element but which properties are not associated with the given element.
   P20. The non-transitory computer readable medium of any of P16-P19, wherein a target element from the plurality of elements has a set property that is bound to another element property, said another element property specified by a property source, and wherein:
the graphical user interface comprises:
a first graphical device representing the target element and a second graphical device representing the property source; and
a graphical element graphically linking the target element to the property source.
   P21. A non-transitory computer readable medium having computer-executable code stored thereon, the computer-executable code, when executed by a computer, configured to cause the computer to execute a method, the method comprising any of P1-P10.

Various embodiments of this disclosure may be implemented at least in part in any conventional computer programming language. For example, some embodiments may be implemented in a procedural programming language (e.g., “C”), or in an object-oriented programming language (e.g., “C++”), or in Python, R, Java, LISP or Prolog. Other embodiments of this disclosure may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transitory computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of this disclosure may be implemented as a combination of both software (e.g., a computer program product) and hardware. Still other embodiments of this disclosure are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A computer-implemented method for providing a graphical user interface for editing lines of hierarchical markup language code, the method comprising:
accessing the lines of hierarchical markup language code, the hierarchical markup language code comprising a plurality of elements, each element comprising a corresponding subset of lines from the hierarchical markup language code, the plurality of elements having a predetermined order within the hierarchical markup language code;
parsing the lines of hierarchical markup language code into the plurality of elements;
generating a plurality of graphical devices, each graphical device uniquely corresponding to a corresponding element of the plurality of elements and representing its corresponding element, each graphical device selectable by a user; and
generating a graphical user interface for display on a computer display, the graphical user interface comprising the plurality of graphical devices arranged in the predetermined order of the elements.

2. The computer-implemented method of claim 1, further comprising:
receiving, from the user, selection of a graphical device, said graphical device being a selected graphical device; and in response to receiving such selection,
updating the selected graphical device to display its corresponding set of lines from the lines of hierarchical markup language code.

3. The computer-implemented method of claim 2, further comprising:
receiving, from the user at the selected graphical device, edits to at least one line of the set of lines of code associated with the element represented by the selected graphical device.

4. The computer-implemented method of claim 1, wherein:
for a given element corresponding to a given graphical device from the plurality of graphical devices, the given element has an associated property; and wherein the graphical user interface comprises:
an associated properties graphical panel configured to display the associated property.

5. The computer-implemented method of claim 1, wherein:
for a given element corresponding to a given graphical device from the plurality of graphical devices, there exists a set of properties available and configured to be associated with the given element, but which properties are not associated with the given element; and wherein the graphical user interface comprises:
an available properties graphical panel configured to display properties that are available and configured to be associated with the given element but which properties are not associated with the given element.

6. The computer-implemented method of claim 1, wherein a given element of the plurality of elements has an associated bound property, which bound property is specified by a source, said element being a specified element, wherein the graphical user interface comprises:
a first graphical device representing the specified element; and
a second graphical device distinct from the first graphical device, the second graphical device representing the source of the bound property; and
a graphical link graphically connecting the first graphical device and the second graphical device to graphically indicate the source of the associated bound property.

7. The computer-implemented method of claim 1, wherein at least a first element from the plurality of elements is bound to a set of second elements from the plurality of elements by a set of property bindings or resource references, and the graphical user interface comprises:
a graphical filter device configured to be activated by the user and that, when activated by the user, causes the graphical user interface to show the first element and the set of second elements.

8. The computer-implemented method of claim 1, wherein a target element from the plurality of elements has a set property that is bound to another element property, said another element property specified by a property source, and wherein:
the graphical user interface comprises:
a first graphical device representing the target element and a second graphical device representing the property source; and
a graphical element graphically linking the target element to the property source.

9. The computer-implemented method of claim 1, wherein a target element from the plurality of elements has a property that is bound to a specified resource, and wherein the graphical user interface comprises:
a first graphical device representing the target element and a second graphical device representing the specified resource; and
a graphical element graphically linking the target element to the specified resource.

10. The computer-implemented method of claim 1, wherein a target element from the plurality of elements inherits a property from a property source through a set of other elements within a hierarchy of elements within the predetermined order, and wherein the graphical user interface comprises:
a target graphical device representing the target element and a set of second graphical devices representing elements in the hierarchy of elements; and
a graphical element graphically linking the target element to a source graphical device representing the property source, said graphical element graphically running through the set of other elements within the hierarchy to indicate that said other elements within the hierarchy inherit the property.

11. A computer-implemented system for presenting a graphical user interface for editing lines of hierarchical markup language code, the hierarchical markup language code comprising a plurality of elements, each element comprising a corresponding subset of lines from the hierarchical markup language code, the plurality of elements having a predetermined order within the hierarchical markup language code, the system comprising:
a parser configured to parse the lines of hierarchical markup language code into the plurality of elements;
a graphical device generator configured to generate a plurality of graphical devices, each graphical device uniquely corresponding to a corresponding element of the plurality of elements and representing its corresponding element, each graphical device selectable by a user and configured to display its corresponding set of lines from the lines of hierarchical markup language code in response to being selected by the user; and
a graphical user interface generator configured to generate a graphical user interface for display on a computer display, the graphical user interface comprising the plurality of graphical devices arranged in the predetermined order of the elements.

12. The computer-implemented system of claim 11, wherein the graphical user interface generator is further configured:
to receive selection, by the user, of a graphical device from the plurality of graphical devices, said graphical device being a selected graphical device; and
to receive from the user, at the selected graphical device, edits to the lines of hierarchical markup language code associated with the element represented by the selected graphical device.

13. The computer-implemented system of claim 11, wherein a given element corresponding to a given graphical device from the plurality of graphical devices has an associated property, and
generating a graphical user interface for display on a computer display comprises generating a graphical display that includes:
an associated properties graphical panel configured to display the associated property.

14. The computer-implemented system of claim 11, wherein a given element of the plurality of elements has an associated bound property, which bound property is specified by a source, said element being a specified element, wherein the graphical user interface comprises:
a first graphical device representing the specified element; and
a second graphical device distinct from the first graphical device, the second graphical device representing the source of the bound property; and
a graphical link graphically connecting the first graphical device and the second graphical device to graphically indicate the source of the associated bound property.

15. The computer-implemented system of claim 11, wherein a target element from the plurality of elements inherits a property from a property source through a set of other elements within a hierarchy of elements, and wherein the graphical user interface comprises:
a target graphical device representing the target element and a set of second graphical devices representing elements in the hierarchy of elements; and
a graphical element graphically linking the target graphical device to a source graphical device representing the property source, said graphical element graphically running through the set of other elements within the hierarchy to indicate that said other elements within the hierarchy inherit the property.

16. A non-transitory computer readable medium having computer-executable code stored thereon, the computer-executable code, when executed by a computer, configured to cause the computer to execute a method, the method comprising:
accessing the lines of hierarchical markup language code, the hierarchical markup language code comprising a plurality of elements, each element comprising a corresponding subset of lines from the hierarchical markup language code, the plurality of elements having a predetermined order within the hierarchical markup language code;
parsing the lines of hierarchical markup language code into the plurality of elements;
generating a plurality of graphical devices, each graphical device uniquely corresponding to a corresponding element of the plurality of elements and representing its corresponding element, each graphical device selectable by a user; and
generating a graphical user interface for display on a computer display, the graphical user interface comprising the plurality of graphical devices arranged in the predetermined order of the elements.

17. The non-transitory computer readable medium of claim 16, wherein the method further comprises:
receiving, from the user, selection of a graphical device, said graphical device being a selected graphical device; and in response to receiving such selection,
updating the selected graphical device to display its corresponding set of lines from the lines of hierarchical markup language code.

18. The non-transitory computer readable medium of claim 16, wherein:
for a given element corresponding to a given graphical device from the plurality of graphical devices, the given element has an associated property; and wherein the graphical user interface comprises:
an associated properties graphical panel configured to display the associated property.

19. The non-transitory computer readable medium of claim 16, wherein:
for a given element corresponding to a given graphical device from the plurality of graphical devices, there exists a set of properties available and configured to be associated with the given element, but which properties are not associated with the given element; and wherein the graphical user interface comprises:
an available properties graphical panel configured to display properties that are available and configured to be associated with the given element but which properties are not associated with the given element.

20. The non-transitory computer readable medium of claim 16, wherein a target element from the plurality of elements has a set property that is bound to another element property, said another element property specified by a property source, and wherein:
the graphical user interface comprises:
a first graphical device representing the target element and a second graphical device representing the property source; and
a graphical element graphically linking the target element to the property source.
